(19) United States
(12) Patent Application Publication
(10) Pub. No.: US 2022/0157485 A1
(43) Pub. Date: May 19, 2022

(54) COMPOSITE ELECTRIC WIRE AND METHOD FOR MANUFACTURING COMPOSITE ELECTRIC WIRE

(71) Applicant: DELTA PLUS CO., LTD., MIE (JP)

(72) Inventors: TSUGIO AMBO, MIE (JP); MASAYASU ITO, MIE (JP); KATSUJI SHIMAZAWA, MIE (JP); EIJI ISHIDA, SAITAMA (JP)

(21) Appl. No.: 17/529,278

(22) Filed: Nov. 18, 2021

(30) Foreign Application Priority Data
Nov. 18, 2020 (JP) 2020-191593
Apr. 30, 2021 (JP) 2021-077841

(51) Int. Cl. H01B 3/30; H01B 13/02; H01B 7/00

(52) U.S. Cl. CPC H01B 3/30; H01B 7/0009; H01B 13/0207

(57) ABSTRACT

[Problem] To obtain a composite electric wire with high electrical conductivity and high plasticity.

[Means for Resolution] A conductive layer 3 is disposed around a central core wire 2 and an insulating coating layer 4 is provided around the conductive layer 3 in a composite electric wire having an outer diameter of approximately 500 μm. The core wire 2 is made of four middle wires 2a to 2d twisted together. Each of the middle wires 2a to 2d is made by twisting a strand made of 48 aramid fibers. As for the conductive layer 3, 12 copper wires 3a with a diameter of 80 μm are closely and spirally wound around the core wire 2 and the circumference of the copper wires 3a is shaped into a circle by tightening.

### FIELD OF THE DISCLOSURE

The present invention relates to a composite electric wire that is small in diameter and can be suitably used for a small crimp connection terminal and a method for manufacturing the composite electric wire.

### BACKGROUND OF THE DISCLOSURE

In recent years, there has been a strong demand for weight reduction and size reduction regarding components used in, for example, various electrical devices. In addition, as for signal wiring, it is necessary to further reduce the sizes of electrical connectors for wiring interconnection with the number thereof increasing as multiple sensors and the like are used.

In order to reduce the size of an electrical connector, it is necessary to reduce the size of a connection terminal used for the electrical connector and the diameter of an electric wire. Recently, connection terminals with a connection diameter of 1 mm or less have begun to be used and electric wires with a diameter of approximately 0.5 mm are required.

In this regard, so-called fiber electric wires unlikely to be cut even in the event of diameter reduction may be used instead of existing copper wires as electric wires. However, a fiber electric wire itself as a conductor is made of a plurality of strands, has poor plasticity, and is easy to disperse and it is difficult for the wire to respond to crimping to a crimp connection terminal.

Described in Patent Document 1 is a metal-coated carbon fiber electric wire in which one base metal layer and one or more metal layers are formed on the upper layer of a conductive carbon fiber. Although the diameter of this electric wire can be reduced, the wire is complicated in terms of manufacturing method and structure.

### CITATION LIST

### Patent Document

Patent Document 1: JP-A-2012-216526

### SUMMARY OF THE DISCLOSURE

### Technical Problem

From such a technical background, there is a demand for an electric wire that is simple in structure, that is rich in conductivity and plasticity, and to which crimping to a crimp connection terminal can be satisfactorily applied.

### Solution to Problem

An object of the invention is to solve the problems described above by providing a composite electric wire and a method for manufacturing the composite electric wire playing a role as a conductor and having predetermined functions such as conductivity and plasticity with a conductive metal wire arranged around a core wire and a low-melting metal satisfactorily bonded to the conductive metal wire.

### Advantageous Effects of the Invention

According to the composite electric wire and the method for manufacturing the composite electric wire according to the invention, a conductive layer in which adjacent wires made of a conductive metal wire are welded and bonded to each other by means of a low-melting metal is disposed on the upper layer of a core wire made of a synthetic resin. As a result, high electrical conductivity is achieved, high plasticity is achieved, diameter reduction can be realized, a satisfactory connection by means of a crimp connection terminal is possible, and manufacturing is facilitated.

In addition, a coating layer made of a synthetic resin material is provided around the core wire, and thus a cleaning liquid cleaning the conductive metal wire does not enter the core wire.

### BRIEF DESCRIPTION OF THE DRAWINGS

FIG. 1 is a cross-sectional view of a composite electric wire of Example 1.

FIG. 2 is an explanatory diagram of a manufacturing process of Example 1.

FIG. 3 is a cross-sectional view of a state where a copper wire is along a core wire.

FIG. 4 is a perspective view of the state where the copper wire is along the core wire.

FIG. 5 is a cross-sectional view of a state where the copper wire is shaped.

FIG. 6 is a cross-sectional of a state where the copper wire is covered with a tin layer.

FIG. 7 is a cross-sectional view of the composite electric wire that is yet to undergo a shaping step.

FIG. 8 is a cross-sectional view of a composite electric wire of Example 2.

FIG. 9 is an explanatory diagram of a manufacturing process of Example 2.

FIG. 10 is a perspective view of a state where a core wire is surrounded by a coating layer with a copper wire placed therealong.

FIG. 11 is a cross-sectional view of a state where the copper wire is shaped.

FIG. 12 is a cross-sectional view of a state where the copper wire is covered with a tin layer.

FIG. 13 is a cross-sectional view of the composite electric wire that is yet to undergo a shaping step.

### DETAILED DESCRIPTION OF THE EXEMPLARY EMBODIMENTS

The invention will be described in detail based on the illustrated examples.

### EXAMPLE 1

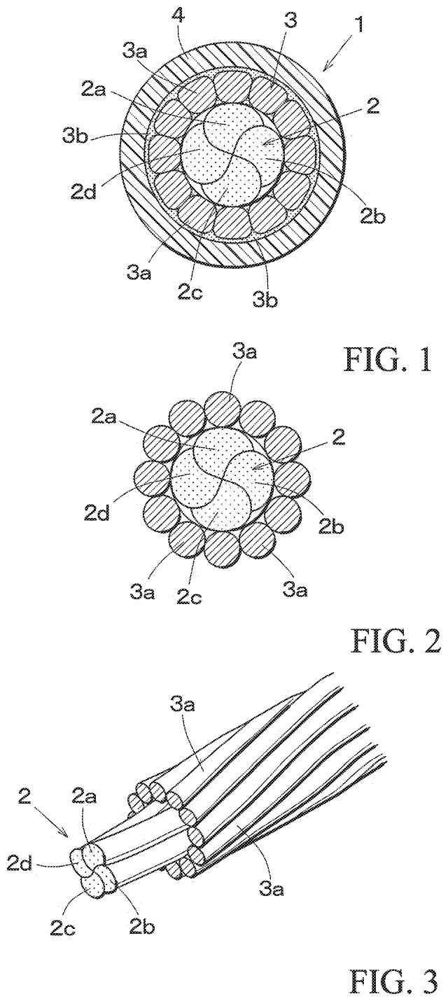

FIG. 1 is a cross-sectional view of a composite electric wire 1 according to Example 1, A conductive layer 3 made of a copper wire 3a and a tin layer 3b is disposed around a core wire 2 and an insulating coating layer 4 is provided around the conductive layer 3 to have flexibility as a whole.

The core wire 2 is made of, for example, four middle wires 2a to 2d twisted together. Each of the middle wires 2a to 2d is made by twisting a synthetic resin material such as a polymer strand made of 48 aramid fibers. The strands have a diameter of, for example, 12 μm. The diameter of the core wire 2 is approximately 200 μm. It should be noted that the aramid fiber is lightweight, has high strength, has high flexibility, and does not have electrical conductivity.

The conductive layer 3 includes a conductive metal wire that has a high melting point, examples of which include the copper wire (Cu: melting point 1085° C.) 3a, and a low melting point metal that bonds adjacent wires of the conductive metal wire to each other, covers the outer surface of the conductive metal wire, and is a metal lower in melting point than the conductive metal wire, examples of which include the tin (Sn: melting point 232° C.) layer 3b.

The copper wire 3a has a diameter of, for example, 80 μm, and 12 copper wires 3a are closely and spirally wound around the core wire 2 by a winding machine. Tin as a low melting point metal is melted and welded therearound, that is, the copper wire 3a is plated such that the circumference of the copper wire 3a is covered with the tin layer 3b and the adjacent wires are bonded to each other. It should be noted that the low melting point in the example is based on the temperature at which the low melting point metal melts in a plating tank to be described later.

The insulating coating layer 4 is formed of a soft synthetic resin material having electrical insulation, covers the upper layer of the conductive layer 3, and has a thickness of, for example, 50 μm. The diameter of the composite electric wire 1 including the insulating coating layer 4 is approximately 500 μm (0.5 mm).

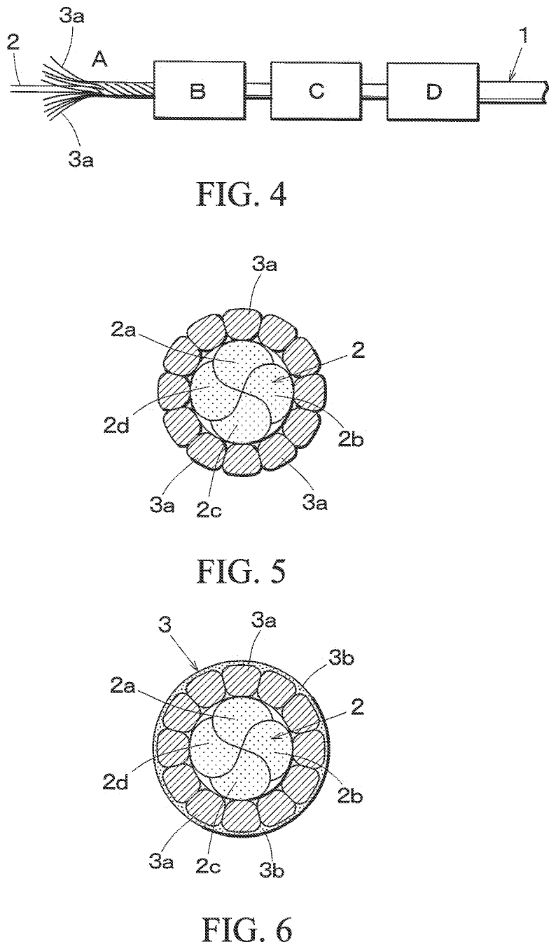

FIG. 2 illustrates a process of manufacturing the composite electric wire 1. In a metal wire winding step A, the copper wire 3a having a diameter of 80 μm as a part of the conductive layer 3 is wound around the core wire 2 by a winding machine. As illustrated in FIGS. 3 and 4, the copper wire 3a is closely and spirally wound around the core wire 2.

Although the middle wires 2a to 2d in the core wire 2 are also loosely twisted in a spiral shape, the copper wire 3a is larger in spiral angle than the middle wires 2a to 2d. In addition, the direction of the spiral of the copper wire 3a is different from the direction of the spiral of the middle wires 2a to 2d and it is preferable that the directions of the spirals intersect with each other such that the copper wire 3a does not bite into the gap of the core wire 2. It should be noted that the copper wire 3a is robust when wound in a spiral shape although the copper wires 3a may be arranged along the longitudinal direction of the core wire 2.

In this manner, the surface of the core wire 2 with the copper wire 3a along the circumference thereof is shaped into a circle as a result of a metal wire shaping step B, in which a die or the like is used and the copper wire 3 a is tightened from the circumference thereof as illustrated in FIG. 5.

Subsequently, in a metal wire plating step C, the core wire 2 around which the copper wire 3a is wound is immersed during feeding into the plating tank in which tin (Sn) as a low melting point metal is melted. In the plating tank, the molten tin covers the surface of the copper wire 3a with a thickness of several micrometers and enters between the adjacent copper wires 3a, forms the tin layer 3b on outer surface of the copper wires 3a, and bonds the adjacent wires to each other. As a result of the metal wire plating step C, the copper wire 3a and the tin layer 3b are integrated, the tin layer 3b covers the outside of the copper wire 3a, and the conductive layer 3 in which the adjacent wires are bonded to each other is formed as illustrated in FIG. 6. The conductive layer 3 gaplessly covers the circumference of the core wire 2.

Further, the circumference of the conductive layer 3 is coated with the insulating coating layer 4 made of a synthetic resin material in an insulating coating step D, in which the core wire 2 with the conductive layer 3 is passed through a coating molding machine. The composite electric wire 1 illustrated in FIG. 1 is obtained as a result.

It should be noted that the composite electric wire 1 may include the core wire 2 and the conductive layer 3 with the insulating coating layer 4 not formed.

The metal wire winding step A, the metal wire shaping step B, the metal wire plating step C, and the insulating coating step D may be continuously carried out on the same production line. Alternatively, the next step may be carried out after one step is completed and the reel is wound once.

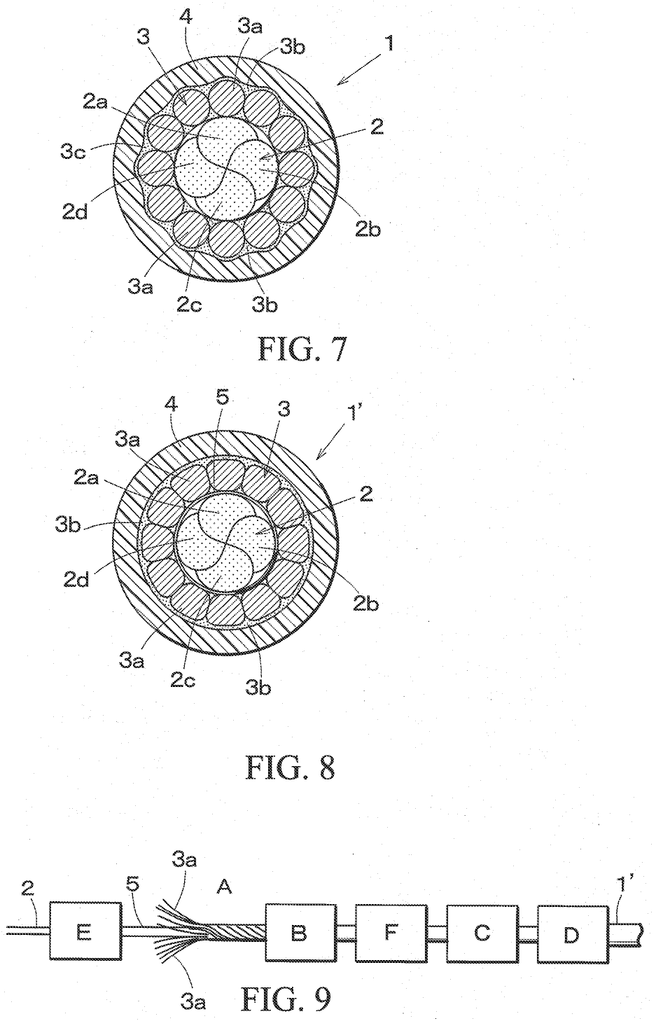

It should be noted that the composite electric wire 1 may be manufactured with the metal wire shaping step B omitted and through the metal wire plating step C and the insulating coating step 1) from the state of the cross-sectional view illustrated in FIG. 3 although the composite electric wire 1 is manufactured through the metal wire shaping step B for the copper wire 3a in Example 1. The composite electric wire 1 as illustrated in FIG. 7 is obtained in this case.

As described above, the conductive layer 3 of the composite electric wire 1 manufactured in Example 1 includes the tin layer 3b and the copper wires 3a, in which adjacent wires are bonded to each other with tin, and completely covers the circumference of the core wire 2.

When the insulating coating layer 4 is peeled off for crimping to a crimp connection terminal, the state illustrated in FIG. 6 occurs and the conductive layer 3 prevents the core wire 2 and the copper wire 3a from dispersing. In addition, the composite electric wire 1 has plasticity attributable to the copper wire 3a, and thus the composite electric wire 1 can be satisfactorily crimped by the crimping piece of the crimp connection terminal.

It should be noted that a conductive metal wire such as an aluminum wire can be used instead of the copper wire 3a in the conductive layer 3. In addition, solder (with a melting point of, for example, 180 to 220° C.) made of, for example, a tin-zinc alloy, which is also a low-melting metal, may be used instead of tin as a low melting point metal in which the copper wires 3a are bonded to each other.

### EXAMPLE 2

8 is a cross-sectional view of a composite electric wire 1′ according to Example 2. In the composite electric wire 1′, a coating layer 5 is provided around the core wire 2, the conductive layer 3 made of the copper wire 3a and the tin layer 3b is disposed outside the coating layer 5, and the insulating coating layer 4 is provided around the conductive layer 3.

Although the core wire 2 is similar in configuration to the core wire 2 of Example 1, the coating layer 5 is provided around the core wire 2, is made of, for example, a polyester-based resin, and has a thickness of several micrometers. In addition, the conductive layer 3 and the insulating coating layer 4 are similar in configuration to those of Example 1.

FIG. 9 is an explanatory diagram of a process of manufacturing the composite electric wire 1′. The process includes a coating step E of applying the coating layer 5 around the core wire 2, the metal wire winding step A of winding the copper wire 3a therearound, a metal wire shaping step B of shaping the outer diameter of the wound copper wire 3a into a circle, a metal wire cleaning step F of cleaning the copper wire 3a, the metal wire plating step B of forming the conductive layer 3 by plating the copper wire 3a with the tin layer 3b, and the insulating coating step D of coating the circumference of the conductive layer 3 with the insulating coating layer 4. It should be noted that the order of the metal wire shaping step B and the metal wire cleaning step F may be reversed.

In the coating step E, the coating layer 5 is applied around the core wire 2 by immersing the core wire 2 in a resin tank in which, for example, a polyester-based resin is melted. The coating layer 5 blocks flux agent infiltration into the core wire 2 in the metal wire cleaning step F to be described later.

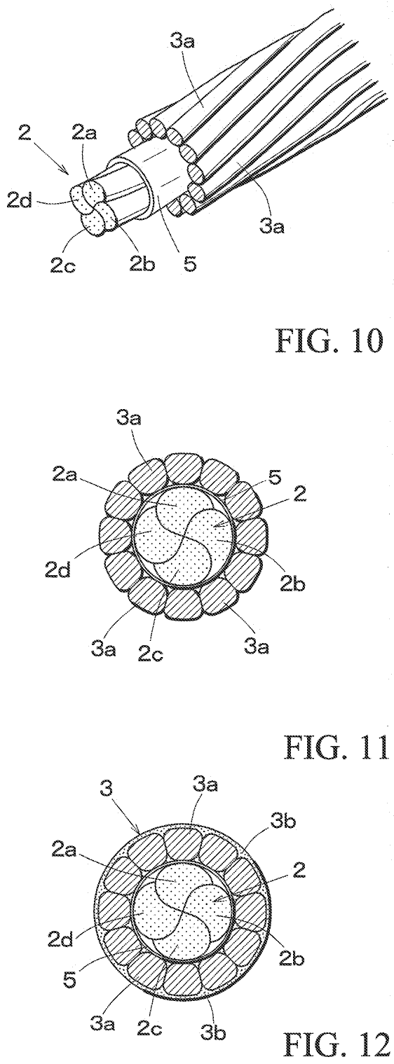

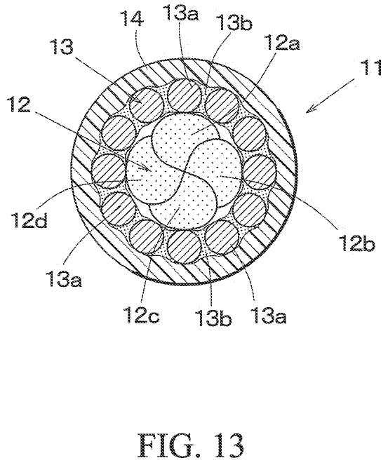

As illustrated in FIG. 10, in the metal wire winding step A, 12 copper wires 3a are spirally wound around the coating layer 5 by a winding machine. In the next metal wire shaping step C, the surrounding copper wires 3a are tightened from the outside and the surface of the copper wires 3a is shaped into a circle as illustrated in FIG. 11.

Subsequently, in the metal wire cleaning step F, the copper wire 3a is pickled with a flux agent through a cleaning tank containing the flux agent made of a strong acid solution or the like such that plating easily adheres to the copper wire 3a in the next step. In this case, the flux agent does not infiltrate into the core wire 2 since the core wire 2 is covered with the coating layer 5.

Next, in the metal wire plating step C, the copper wire 3a is immersed during feeding into the plating tank in which tin (Sn) as a low melting point metal is melted. As illustrated in FIG. 12, the tin melted in the plating tank covers the surface of the copper wire 3a with a thickness of several micrometers and enters between the adjacent copper wires 3a to form the tin layer 3b on the outer surface of the copper wire 3a. In the metal wire plating step C, the copper wire 3a is satisfactorily plated with the tin layer 3b with oil, dirt, or the like removed from the copper wire 3a in the metal wire cleaning step F and the conductive layer 3 in which the adjacent copper wire 3a are bonded to each other is obtained. The conductive layer 3 gaplessly covers the circumference of the core wire 2.

In the metal wire plating step C, the melting point of the tin in the plating tank is 232° C. As a result, the melting point of the coating layer 5 in the case of using a polyester-based synthetic resin is approximately 250° C. and the coating layer 5 is hardly damaged by the molten tin.

Further, in the insulating coating step D, the electric wire provided with the conductive layer 3 is passed through a coating molding machine and the circumference of the conductive layer 3 is coated with the insulating coating layer 4 made of a synthetic resin material. The composite electric wire 1′ illustrated in FIG. 8 is obtained as a result.

It should be noted that the composite electric wire 1′ in Example 2 may be manufactured with the metal wire shaping step B omitted and through the metal wire cleaning step F, the metal wire plating step C, and the insulating coating step D.

### REFERENCE SIGNS LIST

1, 1′ Composite electric wire
2 Core wire
2a to 2d Middle wire
3a Copper wire
3b Tin layer
4 Insulating coating layer
5 Coating layer
A Metal wire winding step
B Metal wire shaping step
C Metal wire plating step
D Insulating coating step
E Coating step
F Metal wire cleaning step

1. A composite electric wire comprising:
a core wire made of a synthetic resin fiber; and
a conductive layer provided around the core wire, wherein
the conductive layer includes a plurality of conductive metal wires and a low melting point metal bonding adjacent wires of the conductive metal wire to each other, covering an outer surface of the conductive metal wire, and lower in melting point than the conductive metal wire,
all the conductive metal wires are in close contact along a surface of the core wire either directly or via the low melting point metal, and
the conductive layer gaplessly covers a circumference of the core wire.

2. The composite electric wire according to claim 1, wherein a coating layer made of a synthetic resin material surrounding the core wire is provided between the core wire and the conductive layer.

3. The composite electric wire according to claim 1, wherein the conductive layer is covered with an insulating coating layer made of a synthetic resin material.

4. The composite electric wire according to claim 1, wherein the conductive metal wire is spirally wound around the core wire.

5. The composite electric wire according to claim 1, wherein the conductive layer has a circular outer circumference.

6. The composite electric wire according to claim 1, wherein the conductive metal wire is a copper wire and the low melting point metal is tin.

7. A method for manufacturing a composite electric wire in which a conductive layer is provided around a core wire made of a synthetic resin fiber, the method comprising:
a metal winding step of closely placing all of a plurality of conductive metal wires along a surface of the core wire; and
a metal wire plating step of plating an outer surface with a low melting point metal by immersing the wound conductive metal wire in the molten low melting point metal, forming the conductive layer by bonding adjacent wires of the conductive metal wire to each other with the low melting point metal, and causing the conductive layer to gaplessly cover a circumference of the core wire.

8. The method for manufacturing a composite electric wire according to claim 7, comprising a coating step of forming a coating layer made of a synthetic resin material around the core wire before the metal wire winding step.

9. The method for manufacturing a composite electric wire according to claim 7, comprising an insulating coating step of coating a surface of the conductive layer with an insulating coating layer made of a synthetic resin material after the metal wire plating step.

10. The method for manufacturing a composite electric wire according to claim 9, comprising a metal wire cleaning step of cleaning the conductive metal wire after the metal wire winding step and before the metal wire plating step.

11. (canceled)
